(19) United States
(12) Patent Application Publication
(10) Pub. No.: US 2016/0084157 A1
(43) Pub. Date: Mar. 24, 2016

(54) WATER-ROTOR-INTERNAL-COMBUSTION ENGINE (WRICE)

(71) Applicant: Charles Hudson, Valdese, NC (US)

(72) Inventor: Charles Hudson, Valdese, NC (US)

(21) Appl. No.: 14/490,776

(22) Filed: Sep. 19, 2014

(51) Int. Cl. F02B 43/10; F02M 25/022

(52) U.S. Cl. CPC F02B 43/10; F02M 25/022; F02B 2043/106

(57) ABSTRACT

A water rotor internal combustion engine for being self powered by use of the electrolysis and combustion of hydrogen gas and oxygen gas. The engine comprises a plurality of rotation wheels, which wheels are in a rotation and combustion chamber. The wheels are mechanically connected to an electrical generator, which generator produces electricity. This electricity in turn is used to electrolyze water, which results in hydrogen gas and oxygen gas to be utilized for said combustion.

### BACKGROUND OF THE INVENTION

1. Field of the Invention

The present invention relates to a water powered internal combustion engine, and more particularly, a WATER ROTOR INTERNAL COMBUSTION ENGINE (WRICE).

2. Description of the Prior Art

Numerous innovations for hydrogen and oxygen powered engines have been provided in the prior art that will be described. Even though these innovations may be suitable for the specific individual purposes to which they address, however, they differ from the present invention.

A FIRST EXAMPLE, U.S. Pat. No. 3,311,097, Published/Issued on Mar. 28, 1967, to Mittelstaedt teaches an invention related to internal combustion engines, to electric cells, and to storage batteries. It also relates to methods and apparatus for producing hydrogen and oxygen gases in an electric cell or battery for use in the intake, combustion and exhaust zones of a combustion engine.

A SECOND EXAMPLE, U.S. Pat. No. 4,003,345, Published/Issued on Jan. 18, 1977, to Bradley teaches an internal combustion engine in which heat is derived from the engine cooling system and/or the exhaust to heat a working fluid in a closed circulatory system. This heat transforms the working fluid into a gas which is delivered to a turbine which drives a generator. The generator delivers DC current to an electrolysis cell in which water is decomposed. The water is decomposed by the electric current into its oxygen and hydrogen components. The oxygen is passed to the air intake of the engine carburetors, while the hydrogen is conveyed to a carburetor therefor. Also included is a carburetor for conventional hydrocarbon fuels. The two carburetors are connected by linkage which may be operated either manually or by pressure to vary the ratio of the carbureted fuels which are delivered to the engine.

Certain auxiliary equipment is provided in the form of an air-cooled condenser in the working fluid system, a supply tank for the hydrocarbon fuel, which ordinarily is gasoline, a water supply tank, a tank for receiving hydrogen under pressure, a pump for the hydrocarbon fuel, a pump for the working fluid system, a pump for delivering water from the water tank to the electrolysis cell and a hydrogen pump which passes hydrogen to the hydrogen carburetor and/or the hydrogen tank.
In a modification, power is derived from the engine exhaust to drive a turbo-generator which delivers DC current to the electrolysis cell. This current may be supplemented by that provided by a generator that is driven by a turbine powered by the working fluid of a system that is heated by the cooling system of the engine.

A THIRD EXAMPLE, U.S. Pat. No. 4,506,631, Published/Issued on Mar. 26, 1985, to Phong-Anant teaches the invention describes a process wherein high-purity hydrogen and oxygen gases can be economically produced via a water electrolysis method, utilizing cheap energy recovered from an incineration process of industrial, municipal, agricultural and other waste materials in a fluidized-bed incinerator. In the said process combustible solid and/or liquid wastes with high energy content are exploited to supply the energy required to incinerate and decompose other solid or liquid wastes with lower or no energy content. Also the process provides a method wherein any solid, liquid or gaseous emissions or effluents from the process are effectively trapped, controlled and converted to environmentally acceptable, inert and harmless products. Also the process includes an energy recovery system such that the thermal energy from the incineration is used to produce steam and generate electricity required for all operations in the process including the production of oxygen. The process does not merely provide competitive and economical means of producing hydrogen and oxygen but also an effective and ultimate disposal method of undesirable and troublesome waste material. It, therefore, is a basis for a profitable commercial operation that combines waste disposal services and manufacturing of marketable products with very low operating costs and flexibility of energy utilization for various industrial and commercial application in either small or large multiple scale.

A FOURTH EXAMPLE, U.S. Pat. No. 4,599,865, Published/Issued on Jul. 15, 1986, to Dalal teaches a method and apparatus for combustion of hydrogen to produce heat, for example to generate steam for power generation. Water is electrolyzed and the hydrogen and a fraction of the oxygen products of electrolysis are passed immediately to a first combustion zone where the immediate combustion of the oxygen products and a function of the hydrogen products is effected. The products from this first combustion zone are immediately passed to a second combustion zone where combustion is again effected with the remaining fraction of the oxygen products of the electrolysis and the remaining hydrogen products from the first combustion zone. The heat generated is thereafter applied to the desired use, for example by passing the products of combustion from the second combustion zone through water to boil the water, the steam thereby produced being used for power generation. Apparatus to carry out this method is also described.

A FIFTH EXAMPLE, U.S. Pat. No. 4,841,731, Published/Issued on Jun. 27, 1989, to Tindell teaches a solar-powered system for supplying large quantitites of usable power consists of an array of photo-voltaic cells which drive an electrolysis generator in which water is converted into oxygen and hydrogen gases. The oxygen and hydrogen gases are initially stored and then mixed in stoichiometric amounts and delivered by means of a water-cooled discharge nozzle to a burner chamber in which the gases are recombined. High pressure steam produced by the oxygen/hydrogen recombination is discharged from the burner to a turbine generator. Condensed water is collected from the turbine and used as distilled water for domestic uses or returned to the electrolysis generator.

A SIXTH EXAMPLE, U.S. Pat. No. 5,279,260, Published/Issued on Jan. 18, 1994, to Munday teaches a water to fuel electrolysis system for providing hydrogen and oxygen gases to a steam boiler for the production of heat and steam.

A SEVENTH EXAMPLE, U.S. Pat. No. 5,900,330, Published/Issued on May 4, 1999, to Kagatani teaches the present invention relates generally to a new power device. More specifically, it creates hydrogen from supplied water and electricity. The hydrogen is then used in combination with air in an electrolysis-electrical cell to produce electric power. All of this is accomplished by first storing the hydrogen in a storage tank or section furnished for such storage, then converting the electricity, via a power converter, to power. Additionally, the power device of the present invention has a special feature whereby the electric power is created from the hydrogen stored in the above mentioned metal alloy hydride storage tanks. The present invention primarily comprises the following four components: (1) an energy source (i.e., a photovoltaic array to convert solar energy to electrical power; a windmill to collect wind power and convert it to electrical power; etc.); (2) a compressor which supplies the electrolysis-fuel cell with oxygen and the hydrogen storage tank with hydrogen from the atmosphere; (3) a hydrogen storage device (i.e., a solid metallic alloy hydride which stores hydrogen through a reversible chemical process); and (4) a hydrogen consumption device (i.e., an electrolysis-fuel cell which consumes the hydrogen released from the tanks (using a heat exchange process) to provide electricity which powers a motor).

AN EIGHTH EXAMPLE, U.S. Pat. No. 6,314,732, Published/Issued on Nov. 13, 2001, to Lookholder teaches a hydrogen-ozone fueled power plant system that can be used for a variety of purposes including vehicles such as automobiles and trucks. The system includes a master generator for producing hydrogen and oxygen from water, another generator for producing ozone using the oxygen produced from the master generator and apparatus for supplying the hydrogen and ozone to the combustion chamber of an internal combustion engine. The steam produced during the combustion cycle is uniquely condensed into water that is returned to the fuel storage tank component of the system that supplies water to the master generator.

A NINTH EXAMPLE, U.S. Pat. No. 6,833,206, Published/Issued on Dec. 21, 2004, to Erdle Et Al. teaches a power supply for an auxiliary power unit APU of a combustion vehicle having a combustion engine includes a fuel cell with a hydrogen input, an oxygen input and an exhaust output, an electrolyzer capable of generating hydrogen and oxygen from water, a hydrogen storage for storing hydrogen produced by the electrolyzer, a water supply (for supplying water to the electrolyzer), and a pressure pump for adjusting the pressure between the water supply and the electrolyzer.

A TENTH EXAMPLE, U.S. Pat. No. 7,043,918, Published/Issued on May 16, 2006, to Lee teaches an environment-friendly engine system is characterized by that hydrogen gas that fuels the engine is generated from water by electrolysis and that the electric power for electrolysis is supplied by a fuel cell in a water fuel tank and a leadacid cell connected in parallel with the fuel cell. As the engine system is operating, the fuel cell burns methyl alcohol or ethyl alcohol to generate power for activating water electrolysis that produces hydrogen gas. The hydrogen gas fuels a hydrogen engine, and the steam produced in the engine is used to drive an electricity generator and subsequently a turbine, whereby the electricity is stored in a leadacid cell used together with the fuel cell. Thereby, the engine system is safe to operate and produces no any of the greenhouse gases, truly friendly to the environment.

It is apparent now that numerous innovations for hydrogen and oxygen based engines have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a(n) WATER-ROTOR-INTERNAL-COMBUSTION ENGINE (WRICE) that avoids the disadvantages of the prior art.

ANOTHER OBJECT of the present invention is to provide a(n) WATER-ROTOR-INTERNAL-COMBUSTION ENGINE (WRICE) that is simple and inexpensive to manufacture.

STILL ANOTHER OBJECT of the present invention is to provide a(n) WATER-ROTOR-INTERNAL-COMBUSTION ENGINE (WRICE) that is simple to use.

BRIEFLY STATED, STILL YET ANOTHER OBJECT of the present invention is to provide a(n) WATER-ROTOR-INTERNAL-COMBUSTION ENGINE (WRICE) that is substantially self powering.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWING

The figures of the drawings are briefly described as follows:

FIG. 1 is a diagrammatic view of a water rotor internal combustion engine;

FIG. 2 is a diagrammatic view of the combustion wheels and distributor ignition system;

FIG. 3 is a diagrammatic view of the control system for the ignition coils;

FIGS. 4 thru 9 are diagrams illustrating the function of the ignition chamber; and

FIG. 10 is a diagrammatic of an anode of the electrolysis unit with parts broken away, it being understood that the cathode is substantially identical.

### A MARSHALING OF REFERENCE NUMERALS UTILIZED IN THE DRAWING

10 water-rotor internal combustion engine
12 electrical generator
14 combustion and rotation chamber
16 rotation wheel
18 ignition chamber
20 electrolysis device
22 anode of electrolysis device 20
24 cathode of electrolysis device 20
26 tank of electrolysis device 20
28 water input of electrolysis device 20
30 hydrogen output of electrolysis device 20
32 oxygen output of electrolysis device 20
34 flywheel
36 ignition coil of ignition chamber 18
38 sprung door of ignition chamber 18
40 top chamber of ignition chamber 18
42 middle chamber of ignition chamber 18
44 bottom chamber of ignition chamber 18
46 first sprung door of ignition chamber 18
48 gaseous water
50 second sprung door of ignition chamber 18
52 third sprung door of ignition chamber 18
54 distributor
56 battery
58 switch

### DETAILED DESCRIPTION OF THE PREFERRED EMBODIMENT

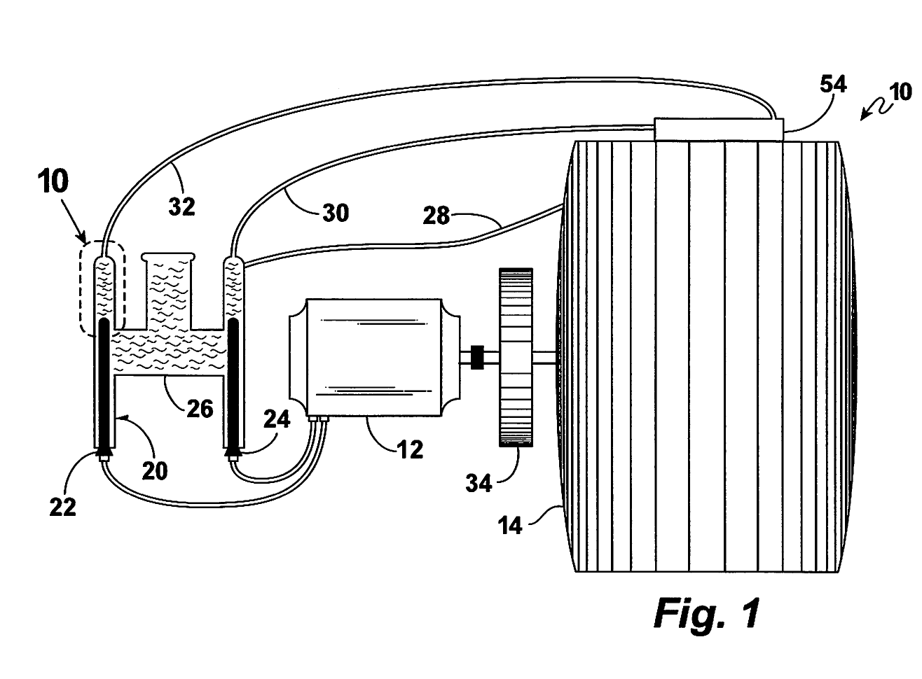

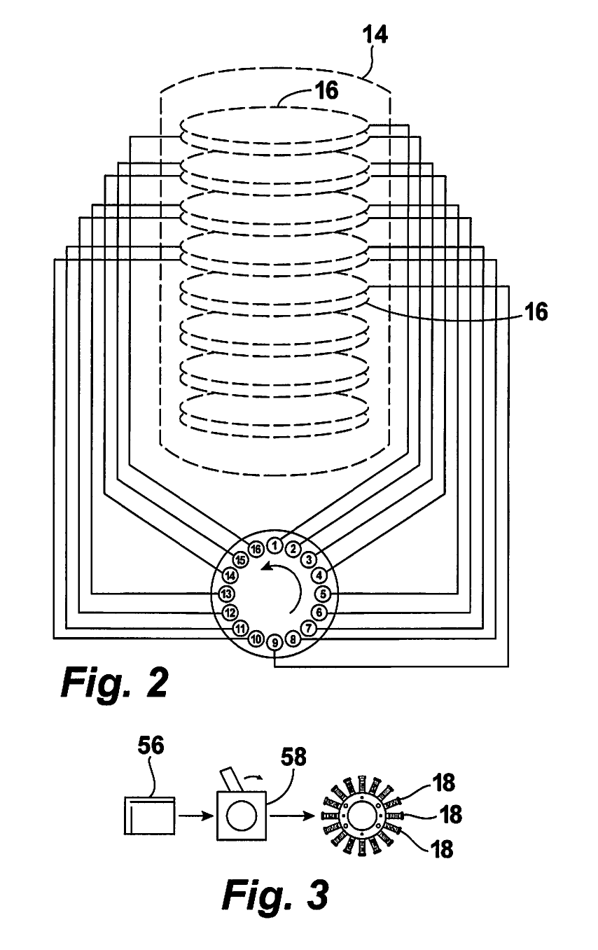

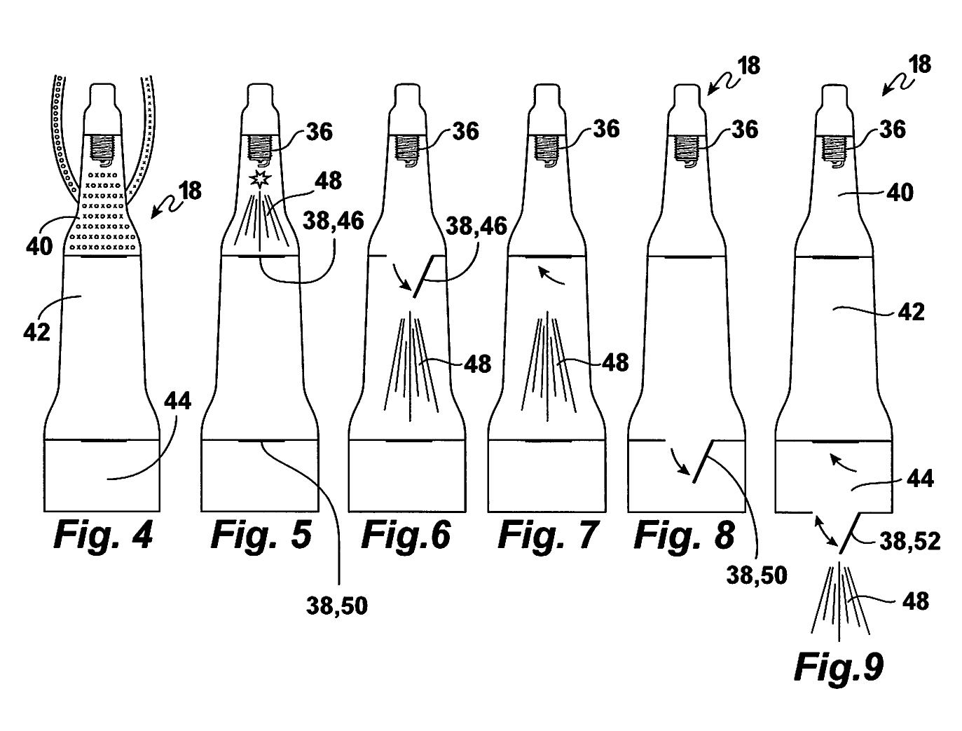

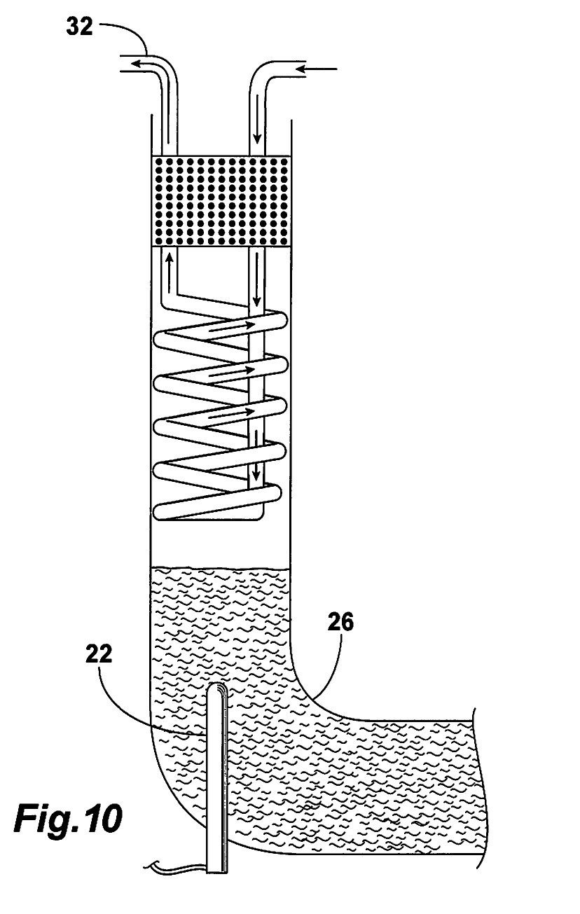

Referring now to the figures, in which like numerals indicate like parts, and particularly to FIG. 1, disclosed is a water-rotor internal combustion engine 10 which comprises:
a) an electrical generator 12;
b) a combustion and rotation chamber 14;
c) a plurality of rotation wheels 16;
c) a plurality of ignition chambers 18; and
d) an electrolysis device 20.

The electrolysis device 20 in turn comprises:
i) an anode 22;
ii a cathode 24;
iii) a tank 26;
iv) a water input 28;
v) a hydrogen output 30; and
vi) an oxygen output 32.

The rotation wheels 16 are within the combustion and rotation chamber 14. The rotation wheels 16 are mounted so that they can rotate on a common axis, and are in mechanical communication with the electrical generator 12. Thus, the electrical generator 12 is powered by the rotation of the rotation wheels 16. The ignition chambers 18 are mounted on the rotation wheels 16, and are for imparting rotational force onto the rotation wheels 16.

The electricity generated by the electrical generator 12 is fed through the anode 22 and the cathode 24 respectively of the electrolysis device 20. The anode 22 and cathode 24 of the electrolysis device 20 are in the tank 26 of the electrolysis device 20.

The water input 28 transfers water from the combustion and rotation chamber 14 to the tank 26 of the electrolysis device 20. The hydrogen output 30 and the oxygen output 32 feed into the plurality of ignition chambers 18.

In the preferred embodiment, the engine 10 further comprises a flywheel 34. The flywheel 34 is for maintaining a more constant rotational velocity for the electric generator 12 and is between the rotation wheels 16 and the electrical generator 12.

The ignition chambers 18 each comprise at least the following:
a) an ignition coil 36;
b) an oxygen gas feed;
c) a hydrogen gas feed; and
d) at least one sprung door 38.

Further, in the preferred construction, the ignition chambers 18 each comprise a top chamber 40, a middle chamber 42, and a bottom chamber 44. The top chamber 40 of each of the ignition chambers 18 is for mixing of hydrogen and oxygen. The ignition coil 36 is located in the top chamber 40 and is for igniting said hydrogen and oxygen.

The top chamber 40 is in mechanical communication with the middle chamber 42 by a first sprung door 38, 46. The first sprung door 38, 46 is for permitting the gaseous water 48 resultant from the ignition of the hydrogen and oxygen to pass from the top chamber 40 to the middle chamber 42.

The middle chamber 42 is in mechanical communication with the bottom chamber 44 by a second sprung door 38, 50. The second sprung door 50 is for permitting the gaseous water 48 resultant from the ignition of the hydrogen and oxygen to pass from said middle chamber to said bottom chamber.

In the preferred construction each ignition chamber 18 further comprises a third sprung door 38, 52. The third sprung door 52 is for releasing the gaseous water 48 from the bottom chamber 44 into the combustion and rotation chamber 14. The first 46, second 50, and third 52 sprung doors 38 are for absorbing kinetic energy produced by the combustion of hydrogen and oxygen and translating that energy to the rotation wheel on which they are mounted.

In the preferred embodiment, the hydrogen output 30 and the oxygen output 32 of the electrolysis device 20 feed the top chambers 40 of the ignition chambers 18 through a distributor 54. The distributor 54 distributes hydrogen and oxygen equally to the ignition chambers 18. There are an equal number of ignition chambers 18 mounted on each of the rotation wheels 16. Further, the ignition coils 36 of those ignition chambers 18 are powered by a battery 56, and that battery is controlled by a switch 58.

It will be understood that each of the elements described above, or two or more together, may also find a useful application in other types of constructions differing from the types described above.

While the invention has been illustrated and described as embodiments of a(n) WATER-ROTOR-INTERNAL-COMBUSTION ENGINE (WRICE), accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A water-rotor internal combustion engine which comprises:
a) an electrical generator;
b) a combustion and rotation chamber;
c) a plurality of rotation wheels;
d) a plurality of ignition chambers; and
e) an electrolysis device; and
wherein said electrolysis device comprises:
i) an anode;
ii) a cathode;
iii) a tank;
iv) a water input;
v) a hydrogen output; and
vi) an oxygen output
wherein said rotation wheels are within said combustion and rotation chamber;
wherein said plurality of ignition chambers are mounted on said rotation wheels;
wherein said plurality of rotation wheels are in mechanical communication with said electrical generator;
wherein said electrical generator is powered by the rotation of said rotation wheels;
wherein the electricity generated by said electrical generator is fed to said anode and said cathode of said electrolysis device;
wherein said anode and cathode of said electrolysis device are in said tank of said electrolysis device;
wherein said water input transfers water from said combustion and rotation chamber to said tank of said electrolysis device; and
wherein said hydrogen output and said oxygen output feed into said plurality of ignition chambers.

2. The engine of claim 1 wherein said engine further comprises a flywheel; and
wherein said flywheel is between said rotation wheels and said electrical generator.

3. The engine of claim 2 wherein said ignition chambers each comprise an ignition coil, an oxygen gas feed, a hydrogen gas feed, and at least one sprung door.

4. The engine of claim 3 wherein said ignition chambers each comprise a top chamber, a middle chamber, and a bottom chamber.

5. The engine of claim 4 wherein said top chamber of each of said ignition chambers is for mixing of hydrogen and oxygen; and
wherein said ignition coil is for igniting said hydrogen and oxygen.

6. The engine of claim 5 wherein said top chamber is in mechanical communication with said middle chamber by a first sprung door; and
wherein said first sprung door is for permitting the gaseous water resultant from the ignition of said hydrogen and oxygen to pass from said top chamber to said middle chamber.

7. The engine of claim 6 wherein said middle chamber is in mechanical communication with said bottom chamber by a second sprung door; and
wherein said second sprung door is for permitting the gaseous water resultant from the ignition of said hydrogen and oxygen to pass from said middle chamber to said bottom chamber.

8. The engine of claim 7 wherein said engine further comprises a third sprung door;
wherein said third sprung door is for releasing said gaseous water from said bottom chamber into said combustion and rotation chamber; and
wherein said first, second, and third sprung doors are for absorbing kinetic energy produced by the combustion of hydrogen and oxygen and translating that energy to the rotation wheel on which they are mounted.

9. The engine of claim 5 wherein said hydrogen output and said oxygen output feed said top chambers of said ignition chambers through a distributor.

10. The engine of claim 9 wherein said distributor distributes hydrogen and oxygen equally to said ignition chambers; and
wherein there are an equal number of ignition chambers mounted on each of said rotation wheels.

11. The engine of claim 5 wherein said ignition coils are powered by a battery; and
wherein said battery is controlled by a switch.
